(19) United States
(12) Patent Application Publication
(10) Pub. No.: US 2017/0101569 A1
(43) Pub. Date: Apr. 13, 2017

(54) METHODS AND COMPOSITIONS FOR RECHARGING SYSTEMS AND RECHARGED SYSTEMS

(71) Applicant: HONEYWELL INTERNATIONAL INC., MORRIS PLAINS, NJ (US)

(72) Inventors: Samuel F. Yana Motta, East Amherst, NY (US); Michael Petersen, Clarence Center, NY (US); Ronald Peter Vogl, Springville, NY (US); Mark W. Spatz, East Amherst, NY (US); Gustavo Pottker, Amherst, NY (US); Christopher Foutz, Annville, PA (US)

(21) Appl. No.: 15/287,239

(22) Filed: Oct. 6, 2016

Related U.S. Application Data
(60) Provisional application No. 62/238,481, filed on Oct. 7, 2015.

(51) Int. Cl. C09K 5/04; F25B 45/00

(52) U.S. Cl. CPC C09K 5/045; F25B 45/00; C09K 2205/40; C09K 2205/22; C09K 2205/122; C09K 2205/126

(57) ABSTRACT

Disclosed are methods and compositions comprising HFC-32, HFC-125, transHFO-1234ze, HFC-134a and HFO-1234yf that may be used as a replacement refrigerant in existing systems, and particularly used to partially replace R-404A in existing systems. Also disclosed are refrigeration systems, methods and compositions comprising HFO-1234yf, transHFO-1234ze, HFC-134a, HFC-143a, HFC-125, and HFC-32.

### CROSS REFERENCE TO RELATED APPLICATIONS

This application claims priority to U.S. provisional application Ser. No. 62/238,481, filed Oct. 7, 2015, which is incorporated herein by reference.

### FIELD OF THE INVENTION

This invention relates to improved compositions and methods for recharging systems of the type containing a fluid which is involved in carrying out operations, such as heat transfer operations and solvent cleaning operations, that involve a periodic need to add replacement fluids to the system to form an environmentally improved system. The methods relate to improved compositions and methods of recharging heat transfer systems which provide not only environmentally improved systems but also systems with improved heat transfer efficiency and/or capacity, with particular benefit in medium and low temperature refrigeration applications, and in particular aspects methods of recharging systems containing refrigerant R-404A. The present invention also relates to the recharged systems.

### BACKGROUND

Certain systems contain one or more fluids that are involved in carrying-out operations, frequently by circulating and/or otherwise being used in the system. As a result of being so involved in the system operation, it is frequently found that the fluid will leave the system, either by accident (such as would occur as a result of unintentional leakage) or intentionally (because the fluid has lost a desired level of effectiveness). For example, mechanical refrigeration systems and related heat transfer devices such as heat pumps and air conditioners use refrigerant liquids that circulate in the system and provide heating or cooling for industrial, commercial and domestic uses. Fluorocarbon based fluids have found widespread use in many residential, commercial and industrial applications, including as the working fluid in systems such as air conditioning, heat pump and refrigeration systems. Fluorocarbons have also found use in other applications, such as solvent cleaning operations. Because of certain suspected environmental problems, including the relatively high global warming potentials associated with the use of some of the compositions that have heretofore been used in these applications, it has become increasingly desirable to use fluids having low or even zero ozone depletion and global warming potentials, such as certain hydrofluorocarbons (“HFCs”). For example, a number of governments have signed the Kyoto Protocol to protect the global environment and setting forth a reduction of CO₂ emissions (global warming). Thus, there is a need for a low- or non-flammable, non-toxic alternative to replace certain of high global warming HFCs.

One important type of refrigeration system is known as a “medium temperature refrigeration system.” Such systems are particularly important because they are utilized in a wide variety of applications, including domestic refrigeration, commercial refrigeration, industrial refrigeration and transport refrigeration, and are commonly used in the food manufacture, distribution and retail industries. Thus, such systems play a vital role in ensuring that food which reaches the consumer is both fresh and fit to eat. In such medium temperature refrigeration systems, a commonly used refrigerant liquid has been HFC-404A (the combination of HFC-125:HFC-143a:HFC-134a in an approximate 44:52:4 weight ratio is referred to in the art as HFC-404A or R-404A). R-404A has an estimated high Global Warming Potential (GWP) of 3943.

While it has become increasingly important to develop new, more environmentally friendly refrigerant compositions, it has frequently been found that potential refrigerant materials which may have advantages from an environmental standpoint have disadvantages, and in some cases severe disadvantages, associated with one or more of the other properties that are important for a new refrigerant to be successful. For example, a proposed, environmentally friendly, new refrigerant which exhibits a reduced level of capacity and/or efficiency when used in the target system frequently will cause problems not only from an operational standpoint, but also can cause secondary environmental problems that may outweigh any advantage in the GWP or ODP of the proposed new refrigerant.

Another difficulty associated with efforts to decrease the potential environmental impact of the existing, in—place refrigerant base has been identified by applicants. More particularly, it is known in the art that certain refrigeration systems, including particularly large medium—temperature refrigeration systems used in supermarkets and the like, are subject to leaking of existing refrigerant in amounts of up to 50% per year. Accordingly, applicants have recognized that an improvement in the environmental properties of the existing, in—place refrigerant base can be improved by replacing the escaped refrigerant with a new, more environmentally friendly refrigerant. At the same time, for economic and other reasons, it is frequently not feasible to remove the remaining, high GWP refrigerant from the system. Accordingly, methods of replacing an escaped, high GWP refrigerant with a new, low GWP refrigerant can frequently produce a system that has a refrigerant composition which is not the same as either the previously present, high GWP refrigerant nor the new low GWP refrigerant with which it will be replaced. Applicants have found that such an operation will frequently produce an operating refrigerant having a wide possible variety of component concentrations. As a result, it is possible that systems will be created containing a refrigerant that has an improved GWP but may unintentionally have other undesirable properties. Moreover, applicants have found that the judicious selection of the replacement refrigerant which is used, and the amount in which it is used, can have substantial and desirable unexpected advantages in terms of various refrigerant properties, including the capacity and operating efficiency of the system, particularly in medium temperature systems.

### SUMMARY

The present invention provides a refrigerant compositions comprising:
(a) from about 20% to about 30% by weight of HFC-32;
(b) from about 20% to about 30% by weight of HFC-125;
(c) from about 5% to about 20% by weight of HFO-1234ze;
(d) from about 15% to about 25% by weight of HFC-134a, and
(e) from about 10% to about 25% by weight of HFO-1234yf,
   wherein the percentages are based on the total weight of the refrigerants. The refrigerant composition provides advantages when used in the refrigerant systems described herein and particularly when used to recharge existing refrigeration systems. Particularly, the refrigerant composition is used to recharge systems that use R-404A refrigerant.

The refrigerant composition may comprise:
(a) from about 24% to about 27% by weight of HFC-32;
(b) from about 24% to about 27% by weight of HFC-125;
(c) from about 5% to about 10% by weight of HFO-1234ze;
(d) from about 19% to about 22% by weight of HFC-134a, and
(e) from about 15% to about 25% by weight of HFO-1234yf,
   wherein the percentages are based on the total weight of the refrigerants. The refrigerant composition provides advantages when used in the refrigerant systems described herein and particularly when used to recharge existing refrigeration systems. Particularly, the refrigerant composition is used to recharge systems that use 404A refrigerant.
   The present invention provides a refrigerant composition comprising:
i. from about 2.5% to about 15% of HFO-1234yf;
ii. from about 0.5% to about 6% of HFO-1234ze;
iii. from about 5% to about 15% of HFC-134a;
iv. from about 20% to about 45% of HFC-143a;
v. from about 30% to about 40% of HFC-125; and
vi. from about 5% to about 20% of HFC-32,
   with said percentages being based on the total weight of the refrigerants.

The present invention provides a refrigerant composition comprising:
i. from about 3% to about 15% of HFO-1234yf;
ii. from about 1% to about 5% of HFO-1234ze;
iii. from about 7% to about 15% of HFC-134a;
iv. from about 20% to about 45% of HFC-143a;
v. from about 30% to about 40% of HFC-125; and
vi. from about 5% to about 20% of HFC-32,
   with said percentages being based on the total weight of the refrigerants.

The present invention provides a refrigerant composition comprising:
i. from about 5% to about 15% of HFO-1234yf;
ii. from about 2% to about 5% of HFO-1234ze;
iii. from about 7% to about 15% of HFC-134a;
iv. from about 20% to about 45% of HFC-143a;
v. from about 30% to about 40% of HFC-125; and
vi. from about 5% to about 20% of HFC-32.
   with said percentages being based on the total weight of the refrigerants.

Each of the refrigerant compositions described above can be used as a refrigerant in existing systems, particularly existing systems designed for use with R-404A. Also, each of the refrigerant compositions described above can be used to recharge existing refrigeration systems. In particular, the composition is preferably provided to recharge refrigeration systems that use an R-404A refrigerant.

Applicants have surprisingly found that such refrigerant compositions are capable of providing environmental advantages over many existing refrigerants, while at the same time providing unexpected and highly desirable advantages in terms of capacity and/or efficiency in certain refrigeration systems, as explained in more detail hereinafter.

Another aspect provides refrigeration systems, and preferably low or medium temperature refrigeration systems, comprising:
a. at least one compressor, condenser and evaporator in fluid communication;
b. a refrigerant composition contained in said system, said refrigerant composition comprising:
   i. from about 2.5% to about 15% of HFO-1234yf;
   ii. from about 0.5% to about 6% of HFO-1234ze;
   iii. from about 5% to about 15% of HFC-134a;
   iv. from about 20% to about 45% of HFC-143a;
   v. from about 30% to about 40% of HFC-125; and
   vi. from about 5% to about 20% of HFC-32,
      with said percentages being based on the total weight of the refrigerants. The refrigeration system may be a refrigeration system was originally designed for use with R-404A.

The present invention provides methods of recharging an existing heat transfer system comprising:
a. providing a heat transfer system that is less than fully charged with refrigerant comprising R-404A; and
b. adding to said less than fully charged system of step (a) a recharge refrigerant composition comprising:
   i. from about 20% to about 30% by weight of HFC-32;
   ii. from about 20% to about 30% by weight of HFC-125;
   iii. from greater than 0% to about 30% by weight of HFO-1234yf;
   iv. from about greater than 0% to about 30% by weight of HFC-143a;
   v. from greater than 0% to about 30% by weight of HFO-1234ze; and
   vi. from about 15% to about 30% by weight of HFC-134a, with the weight percent being based on the total of the components (i)-(vi), said adding step producing at a least a substantially fully charged system having a refrigerant composition contained therein comprising from about 25% to about 75% by weight of said recharge refrigerant composition.

The present invention provides methods of recharging an existing heat transfer system comprising:
a. providing a heat transfer system that is less than fully charged with refrigerant comprising R-404A; and
b. adding to said less than fully charged system of step a) a recharge refrigerant composition comprising:
   (a) from about 20% to about 30% by weight of HFC-32;
   (b) from about 20% to about 30% by weight of HFC-125;
   (c) from about 5% to about 20% by weight of HFO-1234ze;
   (d) from about 15% to about 25% by weight of HFC-134a, and
   (e) from about 10% to about 25% by weight of HFO-1234yf,
      wherein the weight percent is based on the total of the components (a)-(e). The adding step may provide a substantially fully charged system having a refrigerant composition contained therein comprising from about 25% to about 75% by weight of said recharge refrigerant composition.

### BRIEF DESCRIPTION OF THE DRAWINGS

FIG. 1 shows a comparison of the experimental results as compared to the predicted results for R-404A and the compositions of Example 1 in which various amounts of R-404A have been replaced by an N-40 composition.

FIG. 2 shows a comparison of the compositions of R-404A and the compositions of Example 1 in which various amounts of R-404A have been replaced by an N-40 composition.

FIG. 3 shows the comparison of the predicted versus the actual GWP impact for the replacement of R-404A with various amounts of an N-40 composition.

FIG. 4 shows the reduction in indirect emissions (in equivalent kg of CO₂) that will be realized when operating with various amounts of R-404A replaced by an N-40 composition compared to what would have been predicted as the lowest indirect impact.

### DETAILED DESCRIPTION

The methods and systems of the present invention are useful for providing improved systems of the type which contain operating fluids, and particularly multi-component operating fluids, that are periodically required to be recharged. The recharged systems provided herein exhibit one or more improved properties, including and preferably environmental properties, compared to the system with the original charge. For example, a portion of the original charge may be removed from the system, either intentionally or unintentionally, and should be replaced in order to achieve continued reliable operation of the system. Examples of such systems include, but are not limited to, solvent cleaning systems, such as vapor degreasing systems, and refrigeration systems, such as air-conditioning, low-temperature refrigeration systems and medium-temperature refrigeration systems. It is believed that those skilled in the art will be able to use of the present invention in all such systems in view of the teachings contained herein.

Preferred systems include medium temperature refrigeration systems. Such systems are important in many applications, such as to the food manufacture, distribution and retail industries, and play a vital role in ensuring that food that reaches the consumer is both fresh and fit to eat. In such medium temperature refrigeration systems, one of the refrigerant liquids which has been commonly used is HFC-404A, which has a high estimated Global Warming Potential (GWP) of 3943. The inventors have found that a highly desirable but unexpected advantage can be achieved as a result of using the refrigerant compositions described herein, particularly as part of a system recharge procedure, including substantial environmental advantage and capacity and/or efficiency advantages.

More particularly, the present invention is directed to the use of a replacement refrigerant composition (i.e., a recharge refrigerant) comprising, more preferably consisting essentially of, and even more preferably consisting of (a) from about 10% to about 35% by weight of HFC-32; (b) from about 10% to about 35% by weight of HFC-125; (c) from greater than 0% to about 30% by weight of HFO-1234ze; (d) from about 10% to about 35% by weight of HFC-134a, and (e) from greater than about 0% to about 30% by weight of HFO-1234yf, with said percentages being based on the total weight of the refrigerants. For the purposes of convenience only, but not by way of limitation, refrigerants having components (a)-(e) as described herein (i.e., blends of HFC-32, HFC-125, HFO-1234ze, HFC-134a and HFO-1234yf) are referred to as N-40 compositions. In other words, the N-40 composition refers to the refrigerant composition of HFC-32, HFC-125, HFO-1234ze, HFC-134a and HFO-1234yf that may be used as a replacement refrigerant composition in an existing system, and particularly used to partially replace R-404A in an existing system, such as a medium temperature refrigeration system.

The abbreviations for the HFC and HFO refrigerants are provided below:

| | |
|---|---|
| Difluoromethane, CH₂F₂ | HFC-32 |
| Pentafluoroethane, CF₃CHF₂ | HFC-125 |
| 1,1,1,2-Tetrafluoroethane, CF₃CH₂F | HFC-134a |
| 1,1,1-Trifluoroethane, CF₃CH₃ | HFC-143a |
| 1,3,3,3-Tetrafluoropropene, | HFO-1234ze |
| CFH═CHCF₃ | |
| 2,3,3,3-Tetrafluoropropene, | HFO-1234yf |
| CH₂═CFCF₃ | |

Unless otherwise indicated herein, HFO-1234ze refers to trans-1234ze.

In one aspect, the N-40 composition comprises (a) from about 20% to about 30% by weight, preferably about 24% to about 27% by weight of HFC-32; (b) from about 20% to about 30% by weight, preferably about 24% to about 27% by weight, of HFC-125; (c) from about 5% to about 20% by weight, preferably from about 5% to about 10% by weight, of HFO-1234ze, (d) from about 15% to about 25% by weight, preferably from about 19% to about 22% by weight, of HFC-134a, and (e) from greater than about 10% to about 25% by weight of HFO-1234yf, preferably from about 15% to about 25% by weight, with said percentages being based on the total weight of the refrigerants This composition can be used as a replacement refrigerant composition in an existing system. In particular, the composition can be used to partially replace R-404A in an existing system, such as a medium temperature refrigeration system.

In one aspect, the N-40 composition comprises (a) from about 20% to about 30% by weight of HFC-32; (b) from about 20% to about 30% by weight of HFC-125; (c) from about 5% to about 20% by weight of HFO-1234ze; (d) from about 15% to about 25% by weight of HFC-134a, and (e) from about 10% to about 25% by weight of HFO-1234yf, with said percentages being based on the total weight of the refrigerants. This composition can be used as a replacement refrigerant composition in an existing system. In particular, the composition can be used to partially replace R-404A in an existing system, such as a medium temperature refrigeration system.

In another aspect, the N-40 composition comprises (a) from about 24% to about 27% by weight of HFC-32; (b) from about 24% to about 27% by weight of HFC-125; (c) from about 5% to about 10% by weight of HFO-1234ze; (d) from about 19% to about 22% by weight of HFC-134a, and (e) from about 15% to about 25% by weight of HFO-1234yf, with said percentages being based on the total weight of the refrigerants. This composition can be used as a replacement refrigerant composition in an existing system. In particular, the composition can be used to partially replace R-404A in an existing system, such as a medium temperature refrigeration system. Table 1 below provides N-40 compositions:

TABLE 1

| HFC-32 | HFC-125 | HFC-1234ze | HFC-134a | HFO-1234yf |
|---|---|---|---|---|
| (wt %) | (wt %) | (wt %) | (wt %) | (wt %) |
| 10-35 | 10-35 | >0-30 | 10-35 | >0-30 |
| 26 | 26 | 7 | 21 | 20 |
| 20-30 | 20-30 | 5-20 | 15-25 | 10-25 |
| 20-30 | 20-30 | 5-20 | 15-25 | 15-25 |
| 20-30 | 20-30 | 5-20 | 19-22 | 10-25 |
| 20-30 | 20-30 | 5-10 | 15-25 | 10-25 |
| 20-30 | 24-27 | 5-20 | 15-25 | 10-25 |
| 24-27 | 20-30 | 5-20 | 15-25 | 10-25 |
| 20-30 | 20-30 | 5-20 | 19-22 | 15-25 |
| 20-30 | 20-30 | 5-10 | 15-25 | 15-25 |
| 20-30 | 24-27 | 5-20 | 15-25 | 15-25 |
| 24-27 | 20-30 | 5-20 | 15-25 | 15-25 |
| 20-30 | 20-30 | 5-10 | 19-22 | 10-25 |
| 20-30 | 24-27 | 5-20 | 19-22 | 10-25 |
| 24-27 | 20-30 | 5-20 | 19-22 | 10-25 |
| 20-30 | 24-27 | 5-10 | 15-25 | 10-25 |
| 24-27 | 20-30 | 5-10 | 15-25 | 10-25 |
| 24-27 | 24-27 | 5-20 | 15-25 | 10-25 |
| 20-30 | 20-30 | 5-10 | 19-22 | 15-25 |
| 20-30 | 24-27 | 5-20 | 19-22 | 15-25 |
| 24-27 | 20-30 | 5-20 | 19-22 | 15-25 |
| 20-30 | 24-27 | 5-10 | 15-25 | 15-25 |
| 24-27 | 20-30 | 5-10 | 15-25 | 15-25 |
| 24-27 | 24-27 | 5-20 | 15-25 | 15-25 |
| 20-30 | 24-27 | 5-10 | 19-22 | 10-25 |
| 24-27 | 20-30 | 5-10 | 19-22 | 10-25 |
| 24-27 | 24-27 | 5-20 | 19-22 | 10-25 |
| 24-27 | 24-27 | 5-10 | 15-25 | 10-25 |
| 20-30 | 24-27 | 5-10 | 19-22 | 15-25 |
| 24-27 | 20-30 | 5-10 | 19-22 | 15-25 |
| 24-27 | 24-27 | 5-20 | 19-22 | 15-25 |
| 24-27 | 24-27 | 5-10 | 15-25 | 15-25 |
| 24-27 | 24-27 | 5-10 | 19-22 | 10-25 |
| 24-27 | 24-27 | 5-10 | 19-22 | 15-25 |

Each of the above N-40 compositions may be used as a recharge refrigerant composition in existing refrigeration systems. Particularly, each of the N-40 compositions of Table 1 may be used to partially replace R-404A in an existing refrigeration system. The refrigeration system may be a medium temperature refrigeration system. Thus, each of the N-40 compositions of Table 1 may be used to partially replace R-404A in an existing medium temperature refrigeration system.

As the term is used herein, “recharging” refers to methods in which an existing system, including refrigeration and solvent cleaning systems, containing less than a full charge of existing operating fluid, such as refrigerant or solvent, respectively, but at least about 25% of a full charge of refrigerant, has added thereto a sufficient amount of replacement fluid, such as the N-40 compositions (i.e., blends of HFC-32, HFC-125, HFO-1234ze, HFC-134a and HFO-1234yf) described herein, to produce a system that is fully charged or substantially fully charged.

As used herein, the term “fully charged” means a system, such as a heat transfer or solvent cleaning system, that contains at least the amount of the operating fluid (such as refrigerant or solvent) specified for operation of the system and/or at least the amount of operating fluid which the system is designed to contain under normal operating conditions. As used herein, the term “substantially fully charge” refers to a system that is at least 90% by weight fully charged with the operating fluid. Those skilled in the art should appreciate that the present methods have advantage and utility for recharging of systems that are not fully charged, or substantially fully charged, independent of the means or reasons which have resulted in the system being in that condition. By way of example, it is contemplated that advantages and improvements can be achieved in the operation of existing refrigeration systems by removing a portion of the existing refrigerant, including preferably R-404A, in order to intentionally produce a less than fully charge system according to the present invention. By way of further example, it is contemplated that in certain situations an existing refrigerant system may be in a less than fully charged condition by reason of leakage or other unintentional depletion of refrigerant from the system. Those skilled in the art, based upon the teachings contained herein, will appreciate that the methods of the present invention provide opportunities for significant and unexpected advantage in either of these circumstances as described more fully below.

As used herein, the term “medium temperature” system refers to compression refrigeration systems having an evaporator that operates in at least a portion of the range of from about −15° C. to about 0° C., and the condenser operates at a temperature in at least a portion of the range of from about 20° C. to about 50° C.

As used herein, the term “low temperature” system refers to compression refrigeration systems having an evaporator that operates in at least a portion of the range of from about −40° C. to about −15° C. and a condenser that operates in at least a portion of the range of from about 20° C. to about 50° C.

It has surprisingly found that methods producing refrigeration and methods of recharging existing refrigeration systems according to the present invention, and in particular and preferably such methods involving medium temperature systems, and even more preferably medium temperature systems designed for and/or containing R-404A, can achieved unexpected advantages when the refrigerant composition in the operating system comprises, and preferably consists essentially of, the components in the amounts indicated in the following Table 2 (all amounts are presented based on each value being “about” the amount indicated):

TABLE 2

| | WEIGHT % | | |
|---|---|---|---|
| | | MORE | MOST |
| COMPONENT | PREFERRED | PREFERRED | PREFERRED |
| HFC-32 | 5-20 | 5-20 | 10-16 |
| HFC-125 | 30-40 | 30-40 | 33-37 |
| HFC-143a | 20-45 | 20-45 | 20-32 |
| HFC-134a | 7-15 | 7-15 | 10-15 |
| HFO-1234ze | 1-5 | 2-5 | 2.5-5 |
| HFO-1234yf | 3-15 | 5-15 | 8-12 |

The compositions according to Table 2 may result from the combination of the N-40 compositions (i.e., as disclosed in Table 1) with the residual R-404A in an existing refrigeration system, and particularly in a medium temperature refrigeration system.

The methods comprise adding an N-40 composition of HFC-32, HFC-125, HFO-1234ze, HFC-134a and HFO-1234yf, particularly as provided above in Table 1, to an existing heat transfer system containing, and preferably to an existing heat transfer system having an existing refrigerant consisting essentially of R-404A under conditions effective to produce a recharged system. After recharging, the refrigerant contained in the system may comprise from about 25% by weight to about 75% by weight of the N-40 composition based upon the total weight of refrigerant in the system after recharging is completed. In other aspects, the refrigerant contained in the system may comprise from about 30% to about 70%, about 35 to about 65%, or about 40 to about 60%, based upon the total weight of refrigerant composition in the system after recharging is completed.

The methods of the present invention unexpectedly provide the ability to achieve an operating refrigeration system that is not only environmentally improved compared to the same system operating with R-404A, but which unexpectedly exhibits in operation a capacity and/or efficiency that is greater than would have been expected. More particularly, the capacity of the recharge system is at least about 105% greater than, and even more preferably at least about 107% greater than, the capacity of the same system prior to recharging.

In other preferred aspects of the present invention, the efficiency (as measured by COP) of the recharge system is at least about 105% greater than, more preferably at least about 107% greater than, and even more preferably at least about 109% greater than, the COP of the system prior to recharging.

According to preferred embodiments, the methods of the present invention are carried out under conditions to produce a recharged refrigeration system containing a refrigerant comprising from about 25% to about 75% of an N-40 composition of HFC-32, HFC-125, HFO-1234ze, HFC-134a and HFO-1234yf, with the remainder of the refrigerant in the recharge system being residual R-404A.

The N-40 composition which has been used to form the recharge system comprises (a) from about 20 to about 30% of HFC-32, (b) from about 20 to about 30% of HFC-125, (c) from about 15 to about 25% HFO-1234yf, (d) from about 20 to about 30% of HFC-134a, and (e) from about 5 to about 10% transHFO-1234ze, based on the total components (a)-(e) contained in the N-40 composition introduced into the system during recharging. The N-40 composition used to form the recharge system may have any of the compositions of HFC-32, HFC-125, HFO-1234ze, HFC-134a and HFO-1234yf provided in Table 1. Use of these N-40 composition compositions provides the ability to achieve a recharged heat transfer system that has highly advantageous properties, including a refrigerant having substantially reduced GWP compared to HFC-404A, that is also substantially non-flammable and non-toxic and possess an improved capacity and/or COP (i.e., compared to R-404A) as described above.

The methods and systems of present invention may also be used to advantage in connection with recharging and/or producing recharged medium temperature refrigeration systems. An example of such a medium temperature system and method involves providing cooling in the fresh food compartment of a residential refrigerator.

### Heat Transfer Compositions

Use of the N-40 compositions, for example as provided in Table 1, as replacement, and particularly as a partial replacement, for refrigerant in an existing refrigeration system provides a new heat transfer composition that has unexpected advantages, particularly when used in medium temperature refrigeration systems. These compositions are generally useful in heat transfer applications, that is, as a heating and/or cooling medium, but are particularly well especially useful, as mentioned above, in medium and low temperature refrigeration systems, and preferably in low and/or medium temperature systems, that have heretofore used HFC-404A.

Use of the composition as provided in Table 1 and Table 2 herein provide an advantageous, but difficult to achieve, combination of properties that is exhibited by the present compositions, particularly when used in the preferred systems and methods, and that use of these same components but substantially outside of the identified ranges can have a deleterious effect on one or more of the important properties of the compositions, systems or methods of the invention.

As mentioned above, the compositions of the present invention are capable of achieving a difficult to achieve combination of properties, including particularly low GWP. By way of non-limiting example, the following Table B illustrates the substantial improvement in GWP exhibited by certain compositions of the present invention in comparison to the GWP of HFC-404A, which has a GWP of 3943.

TABLE B

| | | | GWP as a |
|---|---|---|---|
| Composition of the Invention | | | Percentage |
| (weight fraction, based on identified | | | of R-404A |
| components) | Name | GWP | GWP |
| R125/R134a/R143a | R-404A | 3943 | — |
| (0.44/0.04/0.52) | | | |
| R32/R125/R134a/R143a/1234ze/1234yf | A1 | 3409 | 86.5% |
| (0.05/0.4/0.07/0.42/.014/0.04) | | | |
| R32/R125/R134a/R143a/1234ze/1234yf | A2 | 2875 | 72.9% |
| (0.10/0.37/0.11/0.31/.03/0.08) | | | |
| R32/R125/R134a/R143a/1234ze/1234yf | A3 | 2341 | 59.4% |
| (0.16/0.33/0.14/0.21/.04/0.12) | | | |
| R32/R125/R134a/R143a/1234ze/1234yf | A4 | 1807 | 45.8% |
| (0.21/0.30/0.18/0.10/.06/0.16) | | | |

The present invention encompasses the use of any of compositions A1 to A4 in any of the claimed methods.

The compositions of the present invention may include other components for the purpose of enhancing or providing certain functionality to the composition, or in some cases to reduce the cost of the composition. For example, refrigerant compositions according to the present invention, especially those used in vapor compression systems, include a lubricant, generally in amounts of from about 30 to about 50 percent by weight of the composition, and in some cases potentially in amount greater than about 50 percent and other cases in amounts as low as about 5 percent. Commonly used refrigeration lubricants such as Polyol Esters (POEs) and Poly Alkylene Glycols (PAGs), PAG oils, that are used in refrigeration machinery with hydrofluorocarbon (HFC) refrigerants may be used with the refrigerant compositions of the present invention. Commercially available esters include neopentyl glycol dipelargonate, which is available as Emery 2917 (registered trademark) and Hatcol 2370 (registered trademark). Other useful esters include phosphate esters, dibasic acid esters, and fluoroesters. Preferred lubricants include polyalkylene glycols and polyol esters. Polyalkylene glycols are highly preferred in certain embodiments because they are currently in use in applications such as mobile air-conditioning. Of course, different mixtures of different types of lubricants may be used.

Other additives not mentioned herein can also be included by those skilled in the art in view of the teachings contained herein without departing from the novel and basic features of the present invention.

### Heat Transfer Methods and Systems

The present methods, systems and compositions are useful in connection with a wide variety of heat transfer systems in general and refrigeration systems in particular, such as air-conditioning (including both stationary and mobile air conditioning systems), refrigeration, heat-pump systems, and the like. The methods, systems and composition are particularly useful in connection with the replacement of an HFC refrigerant in existing refrigerant systems. In certain preferred aspects, the compositions of the present invention are used in refrigeration systems originally designed for use with an HFC refrigerant, such as, for example, R-404A. The preferred compositions of the present invention tend to exhibit many of the desirable characteristics of R-404A but have a GWP that is substantially lower than that of R-404A while at the same time having a capacity and/or efficiency that is substantially similar to or substantially matches, and preferably is as high as or higher than R-404A. In particular, the present compositions tend to exhibit relatively low global warming potentials (“GWPs”), preferably less than about 2500, more preferably less than about 2400, and even more preferably not greater than about 2300. In certain embodiments, the present compositions have a GWP of about 1500 or less.

The refrigerant compositions provided herein may be used in refrigeration systems which had contained and/or had originally been designed for use with R-404A. Each of the compositions provided in Table 1 and Table 2 above may be used as such a replacement for R-404A. These refrigerant compositions may be used in refrigeration systems containing a lubricant used conventionally with R-404A, such as, polyalkylene glycol oils, and the like, or may be used with other lubricants traditionally used with HFC refrigerants. As used herein the term “refrigeration system” refers generally to any system or apparatus, or any part or portion of such a system or apparatus, which employs a refrigerant to provide cooling. Such refrigeration systems include, for example, air conditioners, electric refrigerators, chillers (including chillers using centrifugal compressors), and the like.

The heat transfer compositions described herein, and particularly the compositions provided in Table 1 and Table 2, may be used to retrofit an existing refrigeration system with or without having to substantially modify the system and with or without having to drain completely the existing refrigerant. In one aspect, part of the refrigerant charge is drained from the system, which part may include more than 5%, 10%, 25%, 50%, 75% of the charge then existing in the system, or the like. The removed refrigerant charge is then replaced with an N-40 composition discussed herein (e.g., the composition provided in Table 1).

Alternatively, rather than partially draining the existing system, the N-40 refrigerant compositions (e.g., the compositions provided in Table 1) may be used to “top off” existing systems after a partial refrigerant leak. Many commercial systems, for example, have relatively high refrigerant leak rates which require routine addition of refrigerant over the life of the system. In one method of the present invention, a refrigerant system is provided with less than the full or designed charge of refrigerant in the system, which may occur as a result of leakage of refrigerant from the system, and an N-40 composition of the present invention is used to recharge the system, preferably during normal recharge maintenance. If the system leaked R-404A, for example, it would be recharged with one of the N-40 compositions identified herein (see e.g., Table 1). The present methods permit such to occur while substantially maintaining capacity of the system, maintaining or improving energy efficiency (lower electricity consumption which equates to lower operating cost for the users), and lowering the GWP of the refrigerant contained in the system (lowering environmental impact). Such a method can be performed regardless of how much refrigerant has leaked, preferably without a blend calculation, and provides a simple (and low cost) way to reduce environmental impact associated with recharging of an existent system without deviating from the routine maintenance schedule of the system.

In accordance with the foregoing, even relatively large amounts of R-404A when used in combination with the N-40 composition (see e.g., Table 1), whether in the form of an unintentional contaminant, as an intentionally added ingredient or as the remaining refrigerant after a system replacement or recharge, do not have a substantially deleterious effect on the performance of the refrigerants and/or refrigeration systems. Conversely, relatively large amounts of the N-40 compositions in R-404A, whether in the form of an unintentional contaminant or as an intentionally added ingredient, do not have a substantially deleterious effect on the performance of the refrigerant. Accordingly, whereas in other cases the presence of such an added amount or contaminant might otherwise disqualify the use of the refrigerant with the added amount or contaminant, according to the methods provided herein the use of such mixtures of refrigerants will generally be acceptable for the intended purpose. Accordingly, one advantage of the methods and compositions of the present invention is that, from a workability standpoint, there is generally not a great incentive to ensure that R-404A is entirely absent from the low GWP refrigerants, and vice versa, and under such circumstances there is an increased possibility that, in the absence of the methods provided by the present invention, substantial and severe problems would arise with the operation of many existing automatic purge systems. However, the present methods overcome these problems and add reliability, safety and efficiency to the systems.

### EXAMPLES

The following examples are provided for the purpose of illustrating the present invention but without limiting the scope thereof.

### Comparative Example 1

For this Comparative Example 1, and for the Examples which follow unless otherwise indicated, medium temperature commercial refrigeration system equipment is used. The system uses a commercially available condensing unit and an evaporator for a walk-in freezer/cooler. The condensing unit is as follows:
a) Manufactured by Keeprite Refrigeration, Brantford, Ontario,
b) Model K350L2 outdoor, air cooled, low temperature, condensing unit equipped with: 460 volts/60 Hz./3 phase electrical,
c) Compressor model 2DF-0300 Copeland compressor, with demand cooling for low temperature conditions, oil separator with solenoid, receiver, two valve flooded head pressure control system, and standard operating controls.

The walk-in cooler is as follows:
a) Manufactured by Keeprite Refrigeration, Model KUCB204DED with electric defrost, low profile DX fed evaporator, with 230 volts/60 Hz./1 phase electrical,
b) Nominal capacity of 17,340 BTUH at −20 deg. F. of saturated suction temperature and 10 deg. F. air to refrigerant temperature difference and nominal air flow rate of 3,200 CFM air flow,
c) Sporlan distributor and TXV (R-404A designed TXV was used).

The evaporator was installed in an environmentally controlled chamber that served as the walk-in freezer/cooler. The condenser unit was installed in another temperature controlled chamber to maintain the ambient temperature condition. Instrumentation was added to the system to measure refrigerant mass flow rate, refrigerant pressure and temperature before and after each component, air temperature and flow in/out of evaporator and condenser, and power to condensing unit and evaporator.

Tests were run in typical freezer temperatures (35° F.) and typical design ambient condition of 95° F. It should be noted that the refrigerant temperatures were typically 5° F. to 15° F. lower than the chamber temperatures. The evaporator superheat given by the TXV was initially set to 10° F. in the baseline.

The unit was operated with R-404A using a TXV designed for use with R-404A. The results for the system using R-404A are provided in Table C1A below:

TABLE C1A
R-404A SYSTEM OPERATION

| | |
|---|---|
| Evaporator Superheat (F.) | 10.2 |
| Compressor Suction Temperature (F.) | 57.6 |
| Evaporating Temperature (F.) | 24.2 |
| Capacity (% of R-404A) | 100 |
| Efficiency (% of R-404A) | 100 |

Based on the results obtained for the actual operation using R-404A, operation of the system is simulated to predict operation of a system with a variety of concentrations of the components R-32:R125:R:134a:HFO1234ze:HFO-1234yf as follows in Table C1B-Predicted, with the capacity and efficiency simulation results for each composition:

TABLE C1B
Predicted

| | R-404A | E1 (20 wt | E2 (40 wt | E3 (60 wt | E4 (80 wt | E5 (100 wt |
|---|---|---|---|---|---|---|
| | (ACTUAL) | % N-40) | % N-40) | % N-40) | % N-40) | % N-40) |
| HFC-32 | 0 | 5.2 | 10.4 | 15.6 | 20.8 | 26 |
| HFC-125 | 44 | 40.4 | 36.8 | 33.2 | 29.6 | 26 |
| HFC-143a | 52 | 41.6 | 31.2 | 20.8 | 10.4 | 0 |
| HFC-134a | 4 | 7.4 | 10.8 | 14.2 | 17.6 | 21 |
| HFO- | 0 | 1.4 | 2.8 | 4.2 | 5.6 | 7 |
| 1234ze | | | | | | |
| HFO- | 0 | 4 | 8 | 12 | 16 | 20 |
| 1234yf | | | | | | |
| Capacity | 100 | 101.5 | 102.7 | 103 | 103 | 102.9 |
| (% of R- | | | | | | |
| 404A) | | | | | | |
| Efficiency | 100 | 101 | 102 | 103 | 104 | 105 |
| (% of R- | | | | | | |
| 404A) | | | | | | |

### Example 1

The compositions E1-E5 which were simulated in Comparative Example 1 were created and tested in the actual system described in Comparative Example 1. The results of this test work in terms of Capacity and Efficiency is reported in Table E1A below:

TABLE E1A
ACTUAL

| | E1 | E2 | E3 | E4 | E5 |
|---|---|---|---|---|---|
| HFC-32 | 5.2 | 10.4 | 15.6 | 20.8 | 26 |
| HFC-125 | 40.4 | 36.8 | 33.2 | 29.6 | 26 |
| HFC-143a | 41.6 | 31.2 | 20.8 | 10.4 | 0 |
| HFC-134a | 7.4 | 10.8 | 14.2 | 17.6 | 21 |
| HFO- | 1.4 | 2.8 | 4.2 | 5.6 | 7 |
| 1234ze | | | | | |
| HFO- | 4 | 8 | 12 | 16 | 20 |
| 1234yf | | | | | |
| Capacity | 105 | 108.5 | 107.5 | 103.5 | 103 |
| (% of R-404A) | | | | | |
| Efficiency | 105.8 | 110.1 | 110.2 | 106.5 | 106 |
| (% of R- | | | | | |
| 404A) | | | | | |

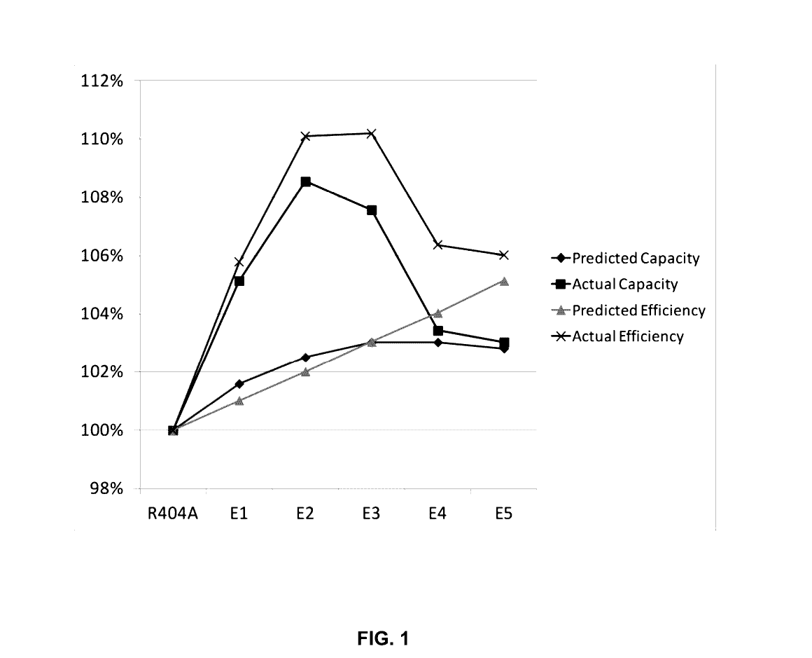

A comparison of the experimental results compared to the predicted results is shown in FIG. 1.

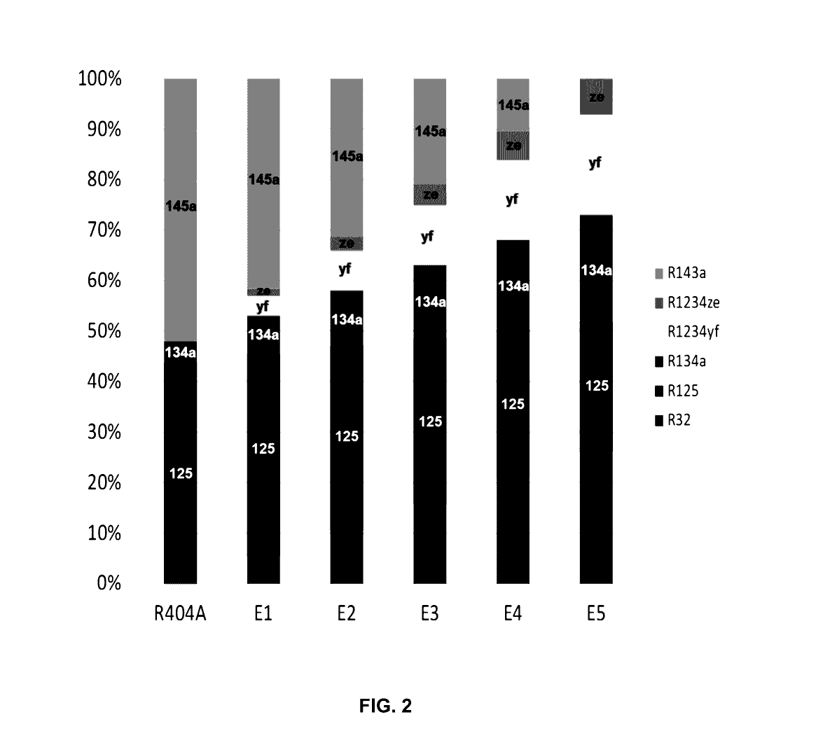

As illustrated in the FIGS. 1 and 2, the inventors have surprisingly found that neither capacity nor efficiency behaves as predicted for certain concentrations of components and that the variation from the predictions is not only substantial but also highly advantageous.

### Comparative Example 2

Using the predicted data obtained in Comparative Example 1 above, the energy usage, and the resulting indirect global warming impact (in kilograms of CO₂ equivalent)) of each of the blends was calculated based on one year of operation (365 days per year and a duty cycle of 0.8) and an initial refrigerant charge of 20 kilograms (kg). The indirect global warming impact is calculated based on the predicted indirect release of GWP compound(s) into the atmosphere based on release of non-refrigerant compounds into the atmosphere, which will occur as a result of the energy required to operate the system under predicted efficiency and capacity. Based on these parameters, the following indirect GWP release and energy usage values were determined as reported in Table C2A:

TABLE C2A
N-40 RECHARGE SIMULATION -
BASED ON PREDICTED VALUES FROM COMPARATIVE EXAMPLE 1

| | Wt % N-40 After Recharge (Example) | | | | | |
|---|---|---|---|---|---|---|
| | 0 | 20 (E1) | 40 (E2) | 60 (E3) | 80 (E4) | 100 (E5) |
| Capacity (% of | 100 | 101.5 | 102.7 | 103 | 103 | 102.9 |
| R-404A) | | | | | | |
| Efficiency (% of | 100 | 101 | 102 | 103 | 104 | 105 |
| R-404A) | | | | | | |
| Refrigerant | 3943 | 3409 | 2875 | 2341 | 1807 | 1273 |
| GWP | | | | | | |
| Energy Usage - | 18921.60 | 18734.26 | 18550.59 | 18370.49 | 18193.85 | 18020.57 |
| Annual | | | | | | |
| (kg/kWh) | | | | | | |
| β (0.65 kg/kWh) * | 12299.04 | 12177.27 | 12057.88 | 11940.82 | 11826.00 | 11713.37 |
| Eₐₙₙᵤₐₗ | | | | | | |
| Indirect Global | 12299.0 | 12177.3 | 12057.9 | 11940.8 | 11826.0 | 11713.4 |
| Warming Impact | | | | | | |
| (kg CO₂) | | | | | | |
| Relative | 100.00% | 99.01% | 98.04% | 97.09% | 96.15% | 95.24% |
| Indirect Global | | | | | | |
| Warming | | | | | | |
| Impact (Based | | | | | | |
| on R-404A) | | | | | | |

### Example 2

Using the actual data obtained in Example 1 above, the energy usage, and the resulting indirect global warming impact (in kilograms of CO₂ equivalent) of each of the blends was calculated based on the same parameters as described above in connection with Comparative Example 2 and the indirect GWP release and energy usage values were calculated and determined to be as reported in Table E2A below:

TABLE E1A
ACTUAL
N-40 RECHARGE SIMULATION -
BASED ON ACTUAL VALUES FROM EXAMPLE 1

| | Wt % N-40 After Recharge (Example) | | | | | |
|---|---|---|---|---|---|---|
| | 0 | 20 (E1) | 40 (E2) | 60 (E3) | 80 (E4) | 100 (E5) |
| Capacity (% of | 100 | 105 | 108.5 | 107.5 | 103.5 | 103 |
| R-404A) | | | | | | |
| Efficiency (% | 100 | 105.8 | 110.1 | 110.2 | 106.5 | 106 |
| of R-404A) | | | | | | |
| Refrigerant | 3943 | 3409 | 2875 | 2341 | 1807 | 1273 |
| GWP | | | | | | |
| Energy Usage - | 18921.60 | 17885.00 | 17185.45 | 17171.39 | 17789.19 | 17847.24 |
| Annual | | | | | | |
| (kg/kWh) | | | | | | |
| β (0.65 kg/kWh) * | 12299.04 | 11625.25 | 11170.54 | 11161.40 | 11562.98 | 11600.71 |
| Eₐₙₙᵤₐₗ | | | | | | |
| Indirect Global | 12299.0 | 11625.2 | 11170.5 | 11161.4 | 11563.0 | 11600.7 |
| Warming | | | | | | |
| Impact (kg | | | | | | |
| CO₂) | | | | | | |
| Relative | 100.00% | 94.52% | 90.82% | 90.75% | 94.02% | 94.32% |
| Indirect Global | | | | | | |
| Warming | | | | | | |
| Impact (Based | | | | | | |
| on R-404A) | | | | | | |
| Indirect Global | 100.00% | 95.47% | 92.64% | 93.47% | 97.78% | 99.04% |
| Warming | | | | | | |
| Impact - Actual | | | | | | |
| compared to | | | | | | |
| predicted | | | | | | |

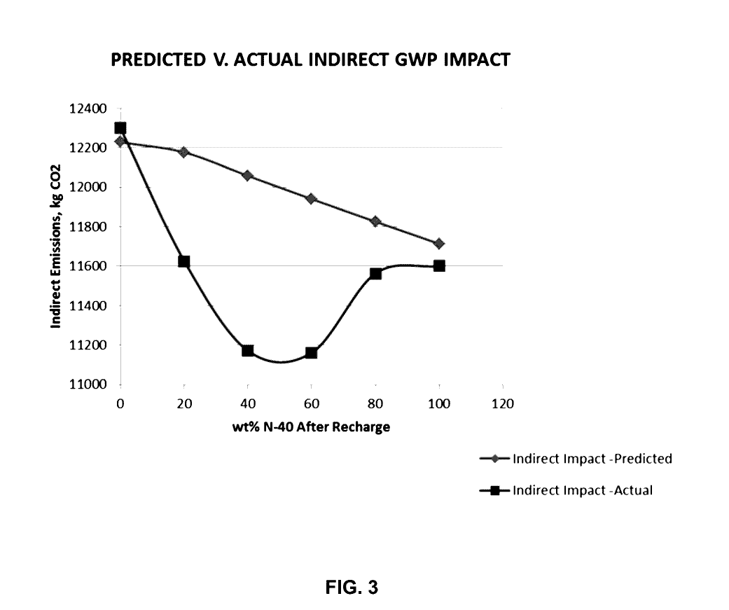

The results reported above illustrate the dramatic and unexpected reduction in indirect GWP emissions by operating within the scope of preferred aspects of the invention compared to the predicted lowest indirect GWP emissions. This is illustrated by the chart shown in FIG. 3 of the results reported in the tables above.

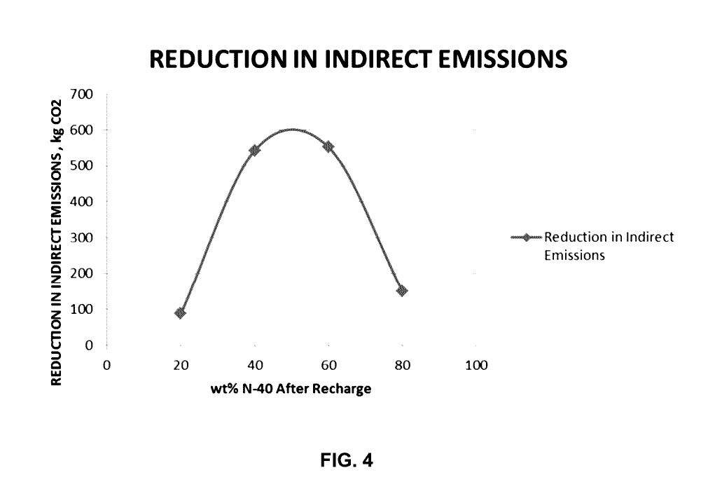

As is illustrated by FIG. 3, the lowest predicted indirect impact would occur when the recharge results in 100% N-40 in the system (E5). However, the actual data shows, unexpectedly, that a significant reduction in indirect global warming emissions can be achieved by not recharging to 100% N-40 and instead recharging within a preferred composition as disclosed herein (greater than about 20% (E1) but less than about 80% (E4)). This is illustrated by FIG. 4, which illustrates the reduction in GWP emissions (in equivalent kg of CO₂) that will be realized by operating in according to the present invention compared to what would have been predicted as the lowest indirect impact.

Thus, based on this single hypothetical system, recharging the refrigerant according to the present invention will unexpectedly reduce the indirect emission of GWP compounds by an amount of from about 100 kilograms to about 600 kilograms per year. This is an important and unexpected result.

Although the invention has been described with reference to preferred embodiments, it will be understood by those skilled in the art that various changes may be made and equivalents may be substituted for elements thereof without departing from the scope of the invention. In addition, many modifications may be made to correspond to a particular situation or material according to the teachings of the invention without departing from the essential scope thereof. Therefore, it is intended that the invention not be limited to the particular embodiments disclosed, but that the invention will include all embodiments falling within the scope of the appended claims or any claims later added.

Aspects of the invention are provided below:
Aspect 1: A refrigeration system comprising:
   a. at least one compressor, condenser and evaporator in fluid communication;
   b. a refrigerant contained in said system, said refrigerant comprising:
      i. from about 2.5% to about 15% of HFO-1234yf;
      ii. from about 0.5% to about 6% of HFO-1234ze;
      iii. from about 5% to about 15% of HFC-134a;
      iv. from about 20% to about 45% of HFC-143a;
      v. from about 30% to about 40% of HFC-125; and
      vi. from about 5% to about 20% of HFC-32, with said percentages being based on weight in the refrigerant.
Aspect 2: The refrigeration system according to aspect 1, wherein the refrigerant comprises about 3% to about 15% of HFO-1234yf.
Aspect 3: The refrigeration system according to aspects 1 or 2, wherein the refrigerant comprises about 5% to about 15% of HFO-1234yf.
Aspect 4: The refrigeration system according to any one of aspects 1 to 3, wherein the refrigerant comprises about 8% to about 12% of HFO-1234yf.
Aspect 5: The refrigeration system according to any one of aspects 1 to 4, wherein the refrigerant comprises about 1% to about 5% of HFO-1234ze.
Aspect 6: The refrigeration system according to any one of aspects 1 to 5, wherein the refrigerant comprises about 2% to about 5% of HFO-1234ze.
Aspect 7: The refrigeration system according to any one of aspects 1 to 6, wherein the refrigerant comprises about 2.5% to about 5% of HFO-1234ze.
Aspect 8: The refrigeration system according to any one of aspects 1 to 7, wherein the refrigerant comprises about 7% to about 15% of HFC-134a.
Aspect 9: The refrigeration system according to any one of aspects 1 to 8, wherein the refrigerant comprises about 10% to about 15% of HFC-134a.
Aspect 10: The refrigeration system according to any one of aspects 1 to 9, wherein the refrigerant comprises about 20% to about 32% of HFC-143a.
Aspect 11: The refrigeration system according to any one of aspects 1 to 10, wherein the refrigerant comprises about 33% to about 37% of HFC-125.
Aspect 12: The refrigeration system according to any one of aspects 1 to 11, wherein the refrigerant comprises about 10% to about 16% of HFC-32.
Aspect 13: A method of providing refrigeration using a medium temperature refrigeration system comprising:
   a. providing at least one compressor discharging a refrigerant in a vapor phase;
   b. providing at least one condenser in fluid communication with the refrigerant vapor discharged from said compressor and operating at a temperature in the range of from about 20° C. to about 50° C. to produce refrigerant in a liquid phase;
   c. providing an evaporator in fluid communication with the liquid phase refrigerant from said condenser and operating at a temperature in the range of from about −40° C. and about 0° C. to produce refrigerant in a vapor phase;
   d. providing refrigerant in said system, said refrigerant comprising:
      i. from about 2.5% to about 15% of HFO-1234yf;
      ii. from about 0.5% to about 5% of HFO-1234ze;
      iii. from about 5% to about 15% of HFC-134a;
      iv. from about 20% to about 45% of HFC-143a;
      v. from about 30% to about 40% of HFC-125; and
      vi. from about 5% to about 20% of HFC-32, with said percentages being based on weight in the refrigerant.
Aspect 14: A method of recharging an existing heat transfer system comprising:
   a. providing a heat transfer system that is less than fully charged with refrigerant, particularly wherein the refrigerant comprises R-404A; and
   b. adding to said less than fully charged system of step (a) a recharge refrigerant composition comprising:
      i. from about 20% to about 30% by weight of HFC-32;
      ii. from about 20% to about 30% by weight of HFC-125;
      iii. from greater than 0% to about 30% by weight of HFO-1234yf;
      iv. from greater than 0% to about 30% by weight of HFO-1234ze; and
      v. from about 15% to about 30% by weight of HFC-134a, with the weight percent being based on the total of the components (i) -(v).
Aspect 15: The method of aspect 14, wherein the adding step (b) produces at least a substantially fully charged system having refrigerant contained therein comprising from about 25% to about 75% by weight of said recharge refrigerant.
Aspect 16: The method of aspect 14 or 15, wherein the recharge refrigerant composition comprises: from about 20% to about 30% by weight of HFC-32,
   from about 20% to about 30% by weight of HFC-125,
   from about 5% to about 20% by weight of HFO-1234ze,
   from about 15% to about 25% by weight of HFC-134a, and
   from about 10% to about 25% by weight of HFO-1234yf.
Aspect 17: The method of aspect 14 or 15, wherein the recharge refrigerant composition comprises:
   from about 24% to about 27% by weight of HFC-32,
   from about 24% to about 27% by weight of HFC-125,
   from about 5% to about 10% by weight of HFO-1234ze,
   from about 19% to about 22% by weight of HFC-134a, and
   from about 15% to about 25% by weight of HFO-1234yf.

Aspect 18: The method of aspect 14 or 15, wherein the recharge refrigerant is selected from a composition that comprises:
20-30 wt. % HFC-32, 20-30 wt. % HFC-125, 5-20 wt. % HFC-1234ze, 15-25 wt. % HFC-134a, and 10-25 wt. % HFO-1234yf;
20-30 wt. % HFC-32, 20-30 wt. % HFC-125, 5-20 wt. % HFC-1234ze, 15-25 wt. % HFC-134a, 15-25 wt. % HFO-1234yf;
20-30 wt. % HFC-32, 20-30 wt. % HFC-125, 5-20 wt. % HFC-1234ze, 19-22 wt. % HFC-134a, 10-25 wt. % HFO-1234yf;
20-30 wt. % HFC-32, 20-30 wt. % HFC-125, 5-10 wt. % HFC-1234ze, 15-25 wt. % HFC-134a, 10-25 wt. % HFO-1234yf;
20-30 wt. % HFC-32, 24-27 wt. % HFC-125, 5-20 wt. % HFC-1234ze, 15-25 wt. % HFC-134a, 10-25 wt. % HFO-1234yf;
24-27 wt. % HFC-32, 20-30 wt. % HFC-125, 5-20 wt. % HFC-1234ze, 15-25 wt. % HFC-134a, 10-25 wt. % HFO-1234yf;
20-30 wt. % HFC-32, 20-30 wt. % HFC-125, 5-20 wt. % HFC-1234ze, 19-22 wt. % HFC-134a, 15-25 wt. % HFO-1234yf;
20-30 wt. % HFC-32, 20-30 wt. % HFC-125, 5-10 wt. % HFC-1234ze, 15-25 wt. % HFC-134a, 15-25 wt. % HFO-1234yf;
20-30 wt. % HFC-32, 24-27 wt. % HFC-125, 5-20 wt. % HFC-1234ze, 15-25 wt. % HFC-134a, 15-25 wt. % HFO-1234yf;
24-27 wt. % HFC-32, 20-30 wt. % HFC-125, 5-20 wt. % HFC-1234ze, 15-25 wt. % HFC-134a, 15-25 wt. % HFO-1234yf;
20-30 wt. % HFC-32, 20-30 wt. % HFC-125, 5-10 wt. % HFC-1234ze, 19-22 wt. % HFC-134a, 10-25 wt. % HFO-1234yf;
20-30 wt. % HFC-32, 24-27 wt. % HFC-125, 5-20 wt. % HFC-1234ze, 19-22 wt. % HFC-134a, 10-25 wt. % HFO-1234yf;
24-27 wt. % HFC-32, 20-30 wt. % HFC-125, 5-20 wt. % HFC-1234ze, 19-22 wt. % HFC-134a, 10-25 wt. % HFO-1234yf;
20-30 wt. % HFC-32, 24-27 wt. % HFC-125, 5-10 wt. % HFC-1234ze, 15-25 wt. % HFC-134a, 10-25 wt. % HFO-1234yf;
24-27 wt. % HFC-32, 20-30 wt. % HFC-125, 5-10 wt. % HFC-1234ze, 15-25 wt. % HFC-134a, 10-25 wt. % HFO-1234yf;
24-27 wt. % HFC-32, 24-27 wt. % HFC-125, 5-20 wt. % HFC-1234ze, 15-25 wt. % HFC-134a, 10-25 wt. % HFO-1234yf;
20-30 wt. % HFC-32, 20-30 wt. % HFC-125, 5-10 wt. % HFC-1234ze, 19-22 wt. % HFC-134a, 15-25 wt. % HFO-1234yf; 20-30 wt. % HFC-32, 24-27 wt. % HFC-125, 5-20 wt. % HFC-1234ze, 19-22 wt. % HFC-134a, 15-25 wt. % HFO-1234yf;
24-27 wt. % HFC-32, 20-30 wt. % HFC-125, 5-20 wt. % HFC-1234ze, 19-22 wt. % HFC-134a, 15-25 wt. % HFO-1234yf;
20-30 wt. % HFC-32, 24-27 wt. % HFC-125, 5-10 wt. % HFC-1234ze, 15-25 wt. % HFC-134a, 15-25 wt. % HFO-1234yf; 24-27 wt. % HFC-32, 20-30 wt. % HFC-125, 5-10 wt. % HFC-1234ze, 15-25 wt. % HFC-134a, 15-25 wt. % HFO-1234yf;
24-27 wt. % HFC-32, 24-27 wt. % HFC-125, 5-20 wt. % HFC-1234ze, 15-25 wt. % HFC-134a, 15-25 wt. % HFO-1234yf;
20-30 wt. % HFC-32, 24-27 wt. % HFC-125, 5-10 wt. % HFC-1234ze, 19-22 wt. % HFC-134a, 10-25 wt. % HFO-1234yf;
24-27 wt. % HFC-32, 20-30 wt. % HFC-125, 5-10 wt. % HFC-1234ze, 19-22 wt. % HFC-134a, 10-25 wt. % HFO-1234yf;
24-27 wt. % HFC-32, 24-27 wt. % HFC-125, 5-20 wt. % HFC-1234ze, 19-22 wt. % HFC-134a, 10-25 wt. % HFO-1234yf;
24-27 wt. % HFC-32, 24-27 wt. % HFC-125, 5-10 wt. % HFC-1234ze, 15-25 wt. % HFC-134a, 10-25 wt. % HFO-1234yf; 20-30 wt. % HFC-32, 24-27 wt. % HFC-125, 5-10 wt. % HFC-1234ze, 19-22 wt. % HFC-134a, 15-25 wt. % HFO-1234yf;
24-27 wt. % HFC-32, 20-30 wt. % HFC-125, 5-10 wt. % HFC-1234ze, 19-22 wt. % HFC-134a, 15-25 wt. % HFO-1234yf;
24-27 wt. % HFC-32, 24-27 wt. % HFC-125, 5-20 wt. % HFC-1234ze, 19-22 wt. % HFC-134a, 15-25 wt. % HFO-1234yf;
24-27 wt. % HFC-32, 24-27 wt. % HFC-125, 5-10 wt. % HFC-1234ze, 15-25 wt. % HFC-134a, 15-25 wt. % HFO-1234yf;
24-27 wt. % HFC-32, 24-27 wt. % HFC-125, 5-10 wt. % HFC-1234ze, 19-22 wt. % HFC-134a, 10-25 wt. % HFO-1234yf; or
24-27 wt. % HFC-32, 24-27 wt. % HFC-125, 5-10 wt. % HFC-1234ze, 19-22 wt. % HFC-134a, 15-25 wt. % HFO-1234yf.
Aspect 19: The method of aspect 14 to 18, wherein said recharge composition has a weight ratio of HFC-32:HFC-125 of from about 0.9:1.2 to about 1.2:0.9.
Aspect 20: The method of aspect 14 or 15, wherein the recharge composition comprises about 26 wt. % HFC-32, about 26 wt. % HFC-125, about 21 wt. % HFC-134a, about 7 wt. % HFO-1234ze and about 20 wt. % HFO-1234yf.
Aspect 21: The method of aspect 14 or 15, wherein said recharge composition comprises from greater than 0% to about 15% by weight of HFO-1234ze and from about 10% to about 30% by weight of HFO-1234yf.
Aspect 22: The method of aspect 14 to 21, wherein said recharge has a weight ratio of R134a to a combination of HFO-1234ze and HFO-1234yf between about 5:7 to about 1:1.
Aspect 23: The method of aspects 14 to 22, wherein said HFO-1234yf is provided in said recharge composition an amount of about 20% and HFO-1234ze is provided in an amount of about 9%.
Aspect 24: The method of aspects 14 wherein said HFO-1234yf is provided in said recharge composition in an amount of about 26%.
Aspect 25: The method of aspect 14 to 24, wherein said at least substantially fully charged system has refrigerant contained therein comprising from about 30% to about 70% by weight of said recharge refrigerant.
Aspect 26: The method of aspect 14 to 24, wherein said at least substantially fully charged system has refrigerant contained therein comprising from about 35 to about 65% by weight of said recharge refrigerant.
Aspect 27: The method of aspect 14 to 24, wherein said at least substantially fully charged system has refrigerant contained therein comprising from about 40 to about 60% by weight of said recharge refrigerant.
Aspect 28: The method aspect 14 to 27, wherein the heat transfer system is a medium temperature refrigeration system.
Aspect 29: A method of replacing an existing heat transfer fluid contained in heat transfer system comprising:
   (a) providing an existing heat transfer system containing as the existing heat transfer fluid HFC-404A;
   (b) removing at least a portion of said existing heat transfer fluid from said system to produce a system that is less than fully charged;
   (c) adding into said less than fully charged system recharge refrigerant comprising: (i) from about 20% to about 30% by weight of HFC-32;
   (ii) from about 20% to about 30% by weight of HFC-125; (iii) from about 0% to about 15% by weight of HFO-1234ze; (iv) from about 15% to about 30% by weight of HFO-1234yf; and (v) from about 15% to about 30% by weight of HFC-134a, with the weight percent being based on the total of the components (i)-(v) in the composition, said adding step producing at a least a substantially fully charged system having refrigerant contained therein comprising from about 25% to about 75% by weight of said recharge refrigerant.
Aspect 30: A recharged heat transfer system formed by any of the methods of aspects 14 to 29.
Aspect 31: Use of a refrigerant composition comprising:
   (a) from about 10% to about 35% by weight of HFC-32;
   (b) from about 10% to about 35% by weight of HFC-125;
   (c) from greater than 0% to about 30% by weight of HFO-1234ze;
   (d) from about 10% to about 35% by weight of HFC-134a, and
   (e) from greater than about 0% to about 30% by weight of HFO-1234yf,
      wherein the percentages are based on the total weight of the refrigerants for partially replacing a refrigerant in an existing refrigeration system.
Aspect 32: Use as described in aspect 31, wherein the refrigerant composition comprises:
   (a) from about 10% to about 35% by weight of HFC-32;
   (b) from about 10% to about 35% by weight of HFC-125;
   (c) from greater than 0% to about 30% by weight of HFO-1234ze;
   (d) from about 10% to about 35% by weight of HFC-134a, and
   (e) from greater than 0% to about 30% by weight of HFO-1234yf,
      wherein the percentages are based on the total weight of the refrigerants
Aspect 33: Use as described in aspect 31, wherein the refrigerant composition comprises:
   (a) from about 20% to about 30% by weight of HFC-32;
   (b) from about 20% to about 30% by weight of HFC-125;
   (c) from about 5% to about 20% by weight of HFO-1234ze;
   (d) from about 15% to about 25% by weight of HFC-134a, and
   (e) from about 10% to about 25% by weight of HFO-1234yf,
      wherein the percentages are based on the total weight of the refrigerants.
Aspect 34: Use as described in aspect 31, wherein the refrigerant composition comprises:
   (a) from about 24% to about 27% by weight of HFC-32;
   (b) from about 24% to about 27% by weight of HFC-125;
   (c) from about 5% to about 10% by weight of HFO-1234ze;
   (d) from about 19% to about 22% by weight of HFC-134a, and
   (e) from about 15% to about 25% by weight of HFO-1234yf,
      wherein the percentages are based on the total weight of the refrigerants.
Aspect 35: Use as described in aspect 31, wherein the refrigerant composition is selected from the group consisting of:
   20-30 wt. % HFC-32, 20-30 wt. % HFC-125, 5-20 wt. % HFC-1234ze, 15-25 wt. % HFC-134a, and 10-25 wt. % HFO-1234yf;
   20-30 wt. % HFC-32, 20-30 wt. % HFC-125, 5-20 wt. % HFC-1234ze, 15-25 wt. % HFC-134a, 15-25 wt. % HFO-1234yf;
   20-30 wt. % HFC-32, 20-30 wt. % HFC-125, 5-20 wt. % HFC-1234ze, 19-22 wt. % HFC-134a, 10-25 wt. % HFO-1234yf;
   20-30 wt. % HFC-32, 20-30 wt. % HFC-125, 5-10 wt. % HFC-1234ze, 15-25 wt. % HFC-134a, 10-25 wt. % HFO-1234yf;
   20-30 wt. % HFC-32, 24-27 wt. % HFC-125, 5-20 wt. % HFC-1234ze, 15-25 wt. % HFC-134a, 10-25 wt. % HFO-1234yf;
   24-27 wt. % HFC-32, 20-30 wt. % HFC-125, 5-20 wt. % HFC-1234ze, 15-25 wt. % HFC-134a, 10-25 wt. % HFO-1234yf;
   20-30 wt. % HFC-32, 20-30 wt. % HFC-125, 5-20 wt. % HFC-1234ze, 19-22 wt. % HFC-134a, 15-25 wt. % HFO-1234yf;
   20-30 wt. % HFC-32, 20-30 wt. % HFC-125, 5-10 wt. % HFC-1234ze, 15-25 wt. % HFC-134a, 15-25 wt. % HFO-1234yf;
   20-30 wt. % HFC-32, 24-27 wt. % HFC-125, 5-20 wt. % HFC-1234ze, 15-25 wt. % HFC-134a, 15-25 wt. % HFO-1234yf;
   24-27 wt. % HFC-32, 20-30 wt. % HFC-125, 5-20 wt. % HFC-1234ze, 15-25 wt. % HFC-134a, 15-25 wt. % HFO-1234yf;
   20-30 wt. % HFC-32, 20-30 wt. % HFC-125, 5-10 wt. % HFC-1234ze, 19-22 wt. % HFC-134a, 10-25 wt. % HFO-1234yf;
   20-30 wt. % HFC-32, 24-27 wt. % HFC-125, 5-20 wt. % HFC-1234ze, 19-22 wt. % HFC-134a, 10-25 wt. % HFO-1234yf;
   24-27 wt. % HFC-32, 20-30 wt. % HFC-125, 5-20 wt. % HFC-1234ze, 19-22 wt. % HFC-134a, 10-25 wt. % HFO-1234yf;
   20-30 wt. % HFC-32, 24-27 wt. % HFC-125, 5-10 wt. % HFC-1234ze, 15-25 wt. % HFC-134a, 10-25 wt. % HFO-1234yf;
   24-27 wt. % HFC-32, 20-30 wt. % HFC-125, 5-10 wt. % HFC-1234ze, 15-25 wt. % HFC-134a, 10-25 wt. % HFO-1234yf;
   24-27 wt. % HFC-32, 24-27 wt. % HFC-125, 5-20 wt. % HFC-1234ze, 15-25 wt. % HFC-134a, 10-25 wt. % HFO-1234yf; 20-30 wt. % HFC-32, 20-30 wt. % HFC-125, 5-10 wt. % HFC-1234ze, 19-22 wt. % HFC-134a, 15-25 wt. % HFO-1234yf; 20-30 wt. % HFC-32, 24-27 wt. % HFC-125, 5-20 wt. % HFC-1234ze, 19-22 wt. % HFC-134a, 15-25 wt. % HFO-1234yf; 24-27 wt. % HFC-32, 20-30 wt. % HFC-125, 5-20 wt. % HFC-1234ze, 19-22 wt. % HFC-134a, 15-25 wt. % HFO-1234yf;
   20-30 wt. % HFC-32, 24-27 wt. % HFC-125, 5-10 wt. % HFC-1234ze, 15-25 wt. % HFC-134a, 15-25 wt. % HFO-1234yf;
   24-27 wt. % HFC-32, 20-30 wt. % HFC-125, 5-10 wt. % HFC-1234ze, 15-25 wt. % HFC-134a, 15-25 wt. % HFO-1234yf;
   24-27 wt. % HFC-32, 24-27 wt. % HFC-125, 5-20 wt. % HFC-1234ze, 15-25 wt. % HFC-134a, 15-25 wt. % HFO-1234yf;
   20-30 wt. % HFC-32, 24-27 wt. % HFC-125, 5-10 wt. % HFC-1234ze, 19-22 wt. % HFC-134a, 10-25 wt. % HFO-1234yf;
   24-27 wt. % HFC-32, 20-30 wt. % HFC-125, 5-10 wt. % HFC-1234ze, 19-22 wt. % HFC-134a, 10-25 wt. % HFO-1234yf;
   24-27 wt. % HFC-32, 24-27 wt. % HFC-125, 5-20 wt. % HFC-1234ze, 19-22 wt. % HFC-134a, 10-25 wt. % HFO-1234yf;
   24-27 wt. % HFC-32, 24-27 wt. % HFC-125, 5-10 wt. % HFC-1234ze, 15-25 wt. % HFC-134a, 10-25 wt. % HFO-1234yf;
   20-30 wt. % HFC-32, 24-27 wt. % HFC-125, 5-10 wt. % HFC-1234ze, 19-22 wt. % HFC-134a, 15-25 wt. % HFO-1234yf;
   24-27 wt. % HFC-32, 20-30 wt. % HFC-125, 5-10 wt. % HFC-1234ze, 19-22 wt. % HFC-134a, 15-25 wt. % HFO-1234yf;
   24-27 wt. % HFC-32, 24-27 wt. % HFC-125, 5-20 wt. % HFC-1234ze, 19-22 wt. % HFC-134a, 15-25 wt. % HFO-1234yf;
   24-27 wt. % HFC-32, 24-27 wt. % HFC-125, 5-10 wt. % HFC-1234ze, 15-25 wt. % HFC-134a, 15-25 wt. % HFO-1234yf;
   24-27 wt. % HFC-32, 24-27 wt. % HFC-125, 5-10 wt. % HFC-1234ze, 19-22 wt. % HFC-134a, 10-25 wt. % HFO-1234yf; and
   24-27 wt. % HFC-32, 24-27 wt. % HFC-125, 5-10 wt. % HFC-1234ze, 19-22 wt. % HFC-134a, 15-25 wt. % HFO-1234yf,
      wherein the percentages are based on the total weight of the refrigerants.
Aspect 36: Use as described in aspect 31, wherein the refrigerant composition comprises: about 26 wt. % HFC-32, about 26 wt. % HFC-125, about 7 wt. % HFO-1234ze, 21 wt. % HFC-134a and about 20 wt. % HFO-1234yf, wherein the percentages are based on the total weight of the refrigerants.
Aspect 37: Use as described in any one of aspects 31 to 36 for partially replacing R-404A in an existing refrigeration system.
Aspect 38: Use as described in any one of aspects 31 to 37, wherein the refrigeration system is a medium temperature refrigeration system.
Aspect 39: Use as described in aspect 38, wherein the medium temperature system is a compression refrigeration system having an evaporator that operates in at least a portion of the range of from about −15° C. to about 0° C., and a condenser that operates at a temperature in at least a portion of the range of from about 20° C. to about 50° C.
Aspect 40: Use as described in any one of aspects 31 to 37, wherein the refrigeration system is a low temperature refrigeration system.
Aspect 41: Use as described in aspect 10 wherein the low temperature system is a compression refrigeration system having an evaporator that operates in at least a portion of the range of from about −40° C. to about −15° C. and a condenser that operates in at least a portion of the range of from about 20° C. to about 50° C.
Aspect 42: A method of recharging an existing heat transfer system comprising:
   a. providing a heat transfer system that is less than fully charged with refrigerant; and
   b. adding to said less than fully charged system of step (a) a refrigerant composition as described in any one of aspects 31 to 36
      i. said adding step producing at a least a substantially fully charged system.
Aspect 43: The method as described in aspect 42, wherein the refrigerant after recharging contains therein from about 25% to about 75% by weight of said recharge refrigerant based on the total weight of refrigerant in the system.
Aspect 44: The method as described in aspect 42 or aspect 43, wherein the refrigerant in step (a) comprises R-404A.
Aspect 45: The method as described in any one of aspects 42 to 44, wherein the refrigerant contained in the system may comprise from about 30% to about 70%, about 35 to about 65%, or about 40 to about 60%, of the recharge refrigerant based upon the total weight of refrigerant composition in the system after recharging is completed.
Aspect 46: The method as described in any one of aspects 42 to 45, wherein the capacity of the recharge system is at least about 105% greater than, and even more preferably at least about 107% greater than, the capacity of the same system prior to recharging.
Aspect 47: The method as described in any one of aspects 42 to 46, wherein the efficiency (as measured by COP) of the recharge system is at least about 105% greater than, more preferably at least about 107% greater than, and even more preferably at least about 109% greater than, the COP of the system prior to recharging.
Aspect 48: The method as described in any one of aspects 42 to 47, wherein said refrigeration system is an air-conditioning system (including both stationary and mobile air conditioning systems), refrigeration system or a heat-pump systems.
Aspect 49: The method as described in any one of aspects 42 to 47, wherein the refrigeration systems is an air conditioner, an electric refrigerators, a chiller (including a chiller using a centrifugal compressor).
Aspect 50: The method as described in any one of aspects 42 to 49, wherein part of the refrigerant charge is drained from the system, which part may include more than 5%, 10%, 25%, 50%, 75% of the charge then existing in the system.
Aspect 51: A refrigerant composition comprising:
   i. from about 2.5% to about 15% of HFO-1234yf;
   ii. from about 0.5% to about 6% of HFO-1234ze;
   iii. from about 5% to about 15% of HFC-134a;
   iv. from about 20% to about 45% of HFC-143a;
   v. from about 30% to about 40% of HFC-125; and
   vi. from about 5% to about 20% of HFC-32,
      wherein the percentages are based on the total weight of the refrigerants.
Aspect 52: The refrigerant composition as described in aspect 51, wherein the refrigerant comprises about 3% to about 15% of HFO-1234yf.
Aspect 53: The refrigerant composition as described in aspects 51 or 52, wherein the refrigerant comprises about 5% to about 15% of HFO-1234yf.
Aspect 54: The refrigerant composition as described in any one of aspects 51 to 53, wherein the refrigerant comprises about 8% to about 12% of HFO-1234yf.
Aspect 55: The refrigerant composition as described in any one of aspects 51 to 54, wherein the refrigerant comprises about 1% to about 5% of HFO-1234ze.
Aspect 56: The refrigerant composition as described in any one of aspects 51 to 55, wherein the refrigerant comprises about 2% to about 5% of HFO-1234ze.
Aspect 57: The refrigerant composition as described in any one of aspects 51 to 56, wherein the refrigerant comprises about 2.5% to about 5% of HFO-1234ze.
Aspect 58: The refrigerant composition as described in any one of aspects 51 to 57, wherein the refrigerant comprises about 7% to about 15% of HFC-134a.
Aspect 59: The refrigerant composition as described in any one of aspects 51 to 58, wherein the refrigerant comprises about 10% to about 15% of HFC-134a.
Aspect 60: The refrigerant composition as described in any one of aspects 51 to 59, wherein the refrigerant comprises about 20% to about 32% of HFC-143a.
Aspect 61: The refrigerant composition as described in any one of aspects 51 to 60, wherein the refrigerant comprises about 33% to about 37% of HFC-125.
Aspect 62: The refrigerant composition as described in any one of aspects 51 to 61, wherein the refrigerant comprises about 10% to about 16% of HFC-32.
Aspect 63: A refrigerant composition comprising:
   i. from about 3% to about 15% of HFO-1234yf;
   ii. from about 1% to about 5% of HFO-1234ze;
   iii. from about 7% to about 15% of HFC-134a;
   iv. from about 20% to about 45% of HFC-143a;
   v. from about 30% to about 40% of HFC-125; and
   vi. from about 5% to about 20% of HFC-32,
      wherein the percentages are based on the total weight of the refrigerants.
Aspect 64: The refrigerant composition as described in aspect 63, wherein the refrigerant comprises about 5% to about 15% of HFO-1234yf.
Aspect 65: The refrigerant composition as described in aspects 63 or 64, wherein the refrigerant comprises about 8% to about 12% of HFO-1234yf.
Aspect 66: The refrigerant composition as described in any one of aspects 63 to 65, wherein the refrigerant comprises about 2% to about 5% of HFO-1234ze.
Aspect 67: The refrigerant composition as described in any one of aspects 63 to 66, wherein the refrigerant comprises about 2.5% to about 5% of HFO-1234ze.
Aspect 68: The refrigerant composition as described in any one of aspects 63 to 67, wherein the refrigerant comprises about 10% to about 15% of HFC-134a.
Aspect 69: The refrigerant composition as described in any one of aspects 63 to 68, wherein the refrigerant comprises about 20% to about 32% of HFC-143a.
Aspect 70: The refrigerant composition as described in any one of aspects 63 to 69, wherein the refrigerant comprises about 33% to about 37% of HFC-125.
Aspect 71: The refrigerant composition as described in any one of aspects 63 to 70, wherein the refrigerant comprises about 10% to about 16% of HFC-32.
Aspect 72: A refrigerant composition comprising:

i. from about 5% to about 15% of HFO-1234yf;

ii. from about 2% to about 5% of HFO-1234ze;

iii. from about 7% to about 15% of HFC-134a;

iv. from about 20% to about 45% of HFC-143a;

v. from about 30% to about 40% of HFC-125; and

vi. from about 5% to about 20% of HFC-32.

wherein the percentages are based on the total weight of the refrigerants.
Aspect 73: The refrigerant composition as described in aspect 72, wherein the refrigerant comprises about 8% to about 12% of HFO-1234yf.
Aspect 74: The refrigerant composition as described in aspects 72 or 73, wherein the refrigerant comprises about 2.5% to about 5% of HFO-1234ze.
Aspect 75: The refrigerant composition as described in any one of aspects 72 to 74, wherein the refrigerant comprises about 20% to about 32% of HFC-143a.
Aspect 76: The refrigerant composition as described in any one of aspects 72 to 75, wherein the refrigerant comprises about 33% to about 37% of HFC-125.
Aspect 77: The refrigerant composition as described in any one of aspects 72 to 76, wherein the refrigerant comprises about 10% to about 16% of HFC-32.
Aspect 78: A refrigerant composition comprising:
   i. from about 8% to about 12% of HFO-1234yf;
   ii. from about 2.5% to about 5% of HFO-1234ze;
   iii. from about 10% to about 15% of HFC-134a;
   iv. from about 20% to about 32% of HFC-143a;
   v. from about 33% to about 37% of HFC-125; and
   vi. from about 10% to about 16% of HFC-32,
      wherein the percentages are based on the total weight of the refrigerants.
Aspect 79: A refrigerant composition comprising:
   i. 4% HFO-1234yf;
   ii. 14% of HFO-1234ze;
   iii. 7% HFC-134a;
   iv. 42% of HFC-143a;
   v. 4% HFC-125; and
   vi. 5% of HFC-32,
      wherein the percentages are based on the total weight of the refrigerants.
Aspect 80: A refrigerant composition comprising:
   i. 12% HFO-1234yf;
   ii. 4% of HFO-1234ze;
   iii. 14% HFC-134a;
   iv. 21% of HFC-143a;
   v. 33% HFC-125; and
   vi. 16% of HFC-32,
      wherein the percentages are based on the total weight of the refrigerants.
Aspect 81: A refrigerant composition comprising:
   i. 8% HFO-1234yf;
   ii. 3% of HFO-1234ze;
   iii. 11% HFC-134a,
   iv. 31% of HFC-143a;
   v. 37% HFC-125; and
   vi. 10% of HFC-32,
      wherein the percentages are based on the total weight of the refrigerants.
Aspect 82: A refrigerant composition comprising:
   i. 16% HFO-1234yf;
   ii. 6% of HFO-1234ze;
   iii. 18% HFC-134a;
   iv. 10% of HFC-143a;
   v. 30% HFC-125; and
   vi. 21% of HFC-32,
      wherein the percentages are based on the total weight of the refrigerants.
Aspect 83: A composition comprising a refrigerant composition as described in any one of aspects 51 to 82, and a lubricant.
Aspect 84: A composition as described in aspect 83, wherein the lubricant is present in an amount of from about 30 to about 50 percent by weight of the composition.
Aspect 85: A composition as described in aspect 83, wherein the lubricant is present in an amount of 50% or more by weight of the composition.
Aspect 86: A composition as described in aspect 83, wherein the lubricant is present in an amount of 5% or less by weight of the composition.
Aspect 87: A composition as described in any one of aspects 83 to 86, wherein the lubricant is a Polyol Ester (POEs), a Poly Alkylene Glycol (PAGs) or a PAG oils.
Aspect 88: A composition as described in any one of aspects 83 to 86, wherein the lubricant is a Polyol Ester (POEs).
Aspect 89: A composition as described in any one of aspects 51 to 88 having a global warming potential (“GWP”), less than about 2500.
Aspect 90: A composition as described in any one of aspects 51 to 88 having a global warming potential (“GWP”), less than about 2400.
Aspect 91: A composition as described in any one of aspects 51 to 88 having a global warming potential (“GWP”), less than about 1500.
Aspect 92: A refrigeration system comprising the composition as described in any one of aspects 51 to 91.
Aspect 93: The refrigeration system as described in aspect 92, wherein the refrigeration system is a medium temperature refrigeration system.
Aspect 94: The refrigeration system as described in aspect 92, wherein the refrigeration system is a low temperature refrigeration system.
Aspect 95: The refrigeration system as described in any of aspects 92 to 94, wherein the refrigeration system was originally designed for use with R-404A.

1. A refrigeration system comprising:
a. at least one compressor, condenser and evaporator in fluid communication;
b. a refrigerant contained in said system, said refrigerant comprising:
i. from about 2.5% to about 15% of HFO-1234yf;
ii. from about 0.5% to about 6% of HFO-1234ze;
iii. from about 5% to about 15% of HFC-134a;
iv. from about 20% to about 45% of HFC-143a;
v. from about 30% to about 40% of HFC-125; and
vi. from about 5% to about 20% of HFC-32, with said percentages being based on weight of the refrigerant.

2. The refrigeration system according to claim 1, wherein the refrigerant comprises:
i. from about 3% to about 15% of HFO-1234yf;
ii. from about 1% to about 5% of HFO-1234ze;
iii. from about 7% to about 15% of HFC-134a;
iv. from about 20% to about 45% of HFC-143a;
v. from about 30% to about 40% of HFC-125; and
vi. from about 5% to about 20% of HFC-32.

3. The refrigeration system according to claim 1, wherein the refrigerant comprises:
i. from about 5% to about 15% of HFO-1234yf;
ii. from about 2% to about 5% of HFO-1234ze;
iii. from about 7% to about 15% of HFC-134a;
iv. from about 20% to about 45% of HFC-143a;
v. from about 30% to about 40% of HFC-125; and
vi. from about 5% to about 20% of HFC-32.

4. The refrigeration system according to claim 1, wherein the refrigerant comprises:
i. from about 8% to about 12% of HFO-1234yf;
ii. from about 2.5% to about 5% of HFO-1234ze;
iii. from about 10% to about 15% of HFC-134a;
iv. from about 20% to about 32% of HFC-143a;
v. from about 33% to about 37% of HFC-125; and
vi. from about 10% to about 16% of HFC-32.

5. The refrigeration system according to claim 1, wherein the refrigeration system is a medium temperature refrigeration system.

6. The refrigeration system according to claim 1, wherein the refrigeration system is a low temperature refrigeration system.

7. The refrigeration system according to claim 1, wherein the refrigeration system was originally designed for use with R-404A.

8. The refrigeration system according to claim 1, wherein the refrigerant has a global warming potential less than about 2500.

9. The refrigeration system according claim 1,
wherein the refrigerant has a global warming potential less than about 1500.

10. The refrigeration system according to claim 1, further comprising a lubricant selected from Polyol Esters (POEs) and Poly Alkylene Glycols (PAGs).

11. A method of recharging an existing heat transfer system comprising:
a. providing a heat transfer system that is less than fully charged with refrigerant; and
b. adding to said less than fully charged system of step (a) a recharge refrigerant composition comprising:
i. from about 20% to about 30% by weight of HFC-32;
ii. from about 20% to about 30% by weight of HFC-125;
iii. from greater than 0% to about 30% by weight of HFO-1234yf;
iv. from greater than 0% to about 30% by weight of HFO-1234ze; and
v. from about 15% to about 30% by weight of HFC-134a, with the weight percent being based on the total of the components (i)-(v), said adding step producing at a least a substantially fully charged system.

12. The method of claim 11, wherein the refrigerant after recharging contains therein from about 25% to about 75% by weight of said recharge refrigerant based on the total weight of refrigerant in the system.

13. The method of claim 11, wherein the refrigerant in step (a) comprises R-404A.

14. The method according to claim 11, wherein said recharge composition comprises from greater than 0% to about 15% by weight of HFO-1234ze and from about 10% to about 30% by weight of HFO-1234yf.

15. The method according to claim 11, wherein the recharge refrigerant composition comprises:
from about 20% to about 30% by weight of HFC-32,
from about 20% to about 30% by weight of HFC-125,
from about 5% to about 20% by weight of HFO-1234ze,
from about 15% to about 25% by weight of HFC-134a, and
from about 10% to about 25% by weight of HFO-1234yf.

16. The method according to any of claims 11 to 13 claim 11, wherein the recharge refrigerant composition comprises:
from about 24% to about 27% by weight of HFC-32,
from about 24% to about 27% by weight of HFC-125,
from about 5% to about 10% by weight of HFO-1234ze,
from about 19% to about 22% by weight of HFC-134a, and
from about 15% to about 25% by weight of HFO-1234yf.

17. The method according claim 11, wherein the refrigerant after recharging contains therein from about 30% to about 70% by weight of said recharge refrigerant based on the total weight of refrigerant in the system

18. The method according to claim 11, wherein the heat transfer system is a medium temperature refrigeration system.

19. The method according to claim 11, wherein the heat transfer system is a low temperature refrigeration system.

20. A method of replacing an existing heat transfer fluid contained in a heat transfer system comprising:
(a) providing an existing heat transfer system containing as the existing heat transfer fluid HFC-404A;
(b) removing at least a portion of said existing heat transfer fluid from said system to produce a system that is less than fully charged;
(c) adding into said less than fully charged system a recharge refrigerant comprising:
(i) from about 20% to about 30% by weight of HFC-32;
(ii) from about 20% to about 30% by weight of HFC-125;
(iii) from greater than 0% to about 15% by weight of HFO-1234 ze;
(iv) from greater than 0% to about 30% by weight of HFO-1234 yf; and
(v) from about 15% to about 30% by weight of HFC-134a, with the weight percent being based on the total of the components (i)-(v) in the recharge refrigerant.

21. The method of claim 20, wherein the heat transfer fluid after replacement contains therein from about 25% to about 75% by weight of said recharge refrigerant based on the total weight of refrigerant in the system.

22. The method according claim 20, wherein said recharge composition comprises from greater than 0% to about 15% by weight of HFO-1234 ze and from about 10% to about 30% by weight of HFO-1234 yf.

23. The method according to claim 20, wherein the heat transfer system is a medium temperature refrigeration system.

24. The method according to claim 20, wherein the heat transfer system is a low temperature refrigeration system

25. The method according to claim 20, wherein the recharge refrigerant composition comprises:
from about 20% to about 30% by weight of HFC-32,
from about 20% to about 30% by weight of HFC-125,
from about 5% to about 20% by weight of HFO-1234 ze,
from about 15% to about 25% by weight of HFC-134a, and
from about 10% to about 25% by weight of HFO-1234 yf.

26. The method according to claim 20, wherein the recharge refrigerant composition comprises:
from about 24% to about 27% by weight of HFC-32,
from about 24% to about 27% by weight of HFC-125,
from about 5% to about 10% by weight of HFO-1234 ze,
from about 19% to about 22% by weight of HFC-134a, and
from about 15% to about 25% by weight of HFO-1234 yf.

27. The method according to any of claims 20 to 26 claim 20, wherein the refrigerant after recharging contains therein from about 30% to about 70% by weight of said recharge refrigerant based on the total weight of refrigerant in the system

28. A recharged heat transfer system formed by the method of claim 11.

29. A refrigerant composition comprising:
i. from about 2.5% to about 15% of HFO-1234 yf;
ii. from about 0.5% to about 5% of HFO-1234 ze;
iii. from about 5% to about 15% of HFC-134a;
iv. from about 20% to about 45% of HFC-143a;
v. from about 30% to about 40% of HFC-125; and
vi. from about 5% to about 20% of HFC-32, with said percentages being based on weight in the refrigerant.

30. The refrigerant composition of claim 29, comprising:
i. from about 3% to about 15% of HFO-1234yf;
ii. from about 1% to about 5% of HFO-1234ze;
iii. from about 7% to about 15% of HFC-134a;
iv. from about 20% to about 45% of HFC-143a;
v. from about 30% to about 40% of HFC-125; and
vi. from about 5% to about 20% of HFC-32, with said percentages being based on weight in the refrigerant.

31. The refrigerant composition of claim 29, comprising:
i. from about 5% to about 15% of HFO-1234yf;
ii. from about 2% to about 5% of HFO-1234ze;
iii. from about 7% to about 15% of HFC-134a;
iv. from about 20% to about 45% of HFC-143a;
v. from about 30% to about 40% of HFC-125; and
vi. from about 5% to about 20% of HFC-32, with said percentages being based on weight in the refrigerant.

32. The refrigerant composition of claim 29, comprising:
i. from about 8% to about 12% of HFO-1234yf;
ii. from about 2.5% to about 5% of HFO-1234ze;
iii. from about 10% to about 15% of HFC-134a;
iv. from about 20% to about 32% of HFC-143a;
v. from about 33% to about 37% of HFC-125; and
vi. from about 10% to about 16% of HFC-32, with said percentages being based on weight in the refrigerant.
